(19) United States
(12) Patent Application Publication
(10) Pub. No.: US 2009/0316803 A1
(43) Pub. Date: Dec. 24, 2009

(54) MIMO RECEIVER

(75) Inventors: Özgün Paker, Eindhoven (NL); Job C. Oostveen, Haren (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/097,587

(22) PCT Filed: Dec. 7, 2006
(86) PCT No.: PCT/IB2006/054668

§ 371 Date: Mar. 11, 2009

(30) Foreign Application Priority Data
Dec. 14, 2005 (EP) 05112141.6
Dec. 7, 2006 (IB) PCT/IB2006/054668

(51) Int. Cl. H04L 27/28; H04L 27/06

(52) U.S. Cl. 375/260; 375/340; 375/341

(57) ABSTRACT

In a MIMO receiver, initial solutions using sub-optional decoding algorithm are determined for the symbols transmitted from each of a number of transmit antennas at a given time (100). The initial solutions (Sᵢₙᵢₜ₁, . . . , S_{initNt}) are hard-mapped to the nearest possible symbols of transmission (Sₑₛₜ₁, . . . , S_{estNt}). For each of the nearest possible symbols limited areas around them in the constellation plane are defined. A list of candidate symbol vectors (list) is then determined, including only symbols lying within the limited areas of the constellation plane. Finally, a joint decoding technique such as ML-technique is implemented to determine the best of the candidate symbol vectors. The number of the calculations can thus be significantly reduced, without having excessively damaging effects on the symbol error rate.

This invention relates to a Multiple Input, Multiple Output communications system, and to a receiver and a method of symbol detection for use in such a system.

Multiple Input, Multiple Output (MIMO) communications systems take advantage of spatial multiplexing to increase wireless bandwidth and range. Specifically, MIMO transmitters send information out using two or more antennas, and the information is received via multiple antennas as well. MIMO systems use the additional pathways to transmit more information, and then recombine the signal on the receiving end. MIMO systems provide a significant capacity gain over conventional single antenna systems, along with more reliable communication. MIMO-based transceivers can for example be employed in WLAN 802.11n, WiMax and cellular communications systems.

However, with this increase in capacity comes an increase in calculation complexity. It is a nontrivial task to separate out in the receiver the symbols transmitted from each of the transmit antennas, with the optimal joint decoding techniques requiring large numbers of calculations to be performed in order to obtain a solution. Moreover, the noise added to each signal during its transit between the transmitter and the receiver, largely in the receiver front-end amplifier, further complicates matters, meaning suboptimal, but more rapid, symbol detection techniques can have a large symbol error rate.

Digital communications systems often use signal space diagrams to represent signals, for example the signal being transmitted from a transmitter. For example, in systems using quadrature amplitude modulation (QAM), the in-phase and quadrature components of a signal represent the data being transmitted. Each point represents a symbol, a unique signal state of a modulation scheme which conveys one or more user bits to the receiver. A signal space diagram showing all the possible transmitted symbols is known as a constellation. In MIMO systems, each transmit antenna transmits a symbol, and the set of transmitted symbols at any time forms a symbol vector.

The task of the MIMO receiver is to determine the transmitted symbol vector in each time period, using the detected symbols.

The document US 2004/0066866 discloses a method of decoding space-time coded signals transmitted from a number of transmit antennas. First, a separate detection technique is used to determine initial decoding solutions corresponding to the symbols transmitted from each of a number of transmit antennas at a given time. For each initial solution, a limited area about the initial solution is defined. Each of the limited areas will correspond to regions including constellation points proximate to the initial solution. The initial solutions are used to define a limited, multi-dimensional space. Finally, a joint decoding technique is implemented within the limited space to find a final solution.

However, the multi-dimensional space defined by these initial solutions is still relatively large, meaning that a relatively large number of calculations need to be performed in the joint decoding step.

It is an object of the present invention to provide a method of symbol detection that requires a smaller number of calculations in a decoding step.

The present invention provides a method of identifying transmitted symbol vectors as part of a communications system, wherein a plurality of transmitting antennas each transmit a respective symbol during a time period, each symbol being selected from a plurality of possible transmitted symbols, and the plurality of possible transmitted symbols being represented by a constellation plane, wherein the plurality of symbols transmitted by said plurality of transmitting antennas form a transmitted symbol vector, and wherein the method comprises: receiving a signal over a channel originating from the plurality of transmitting antennas; applying a first algorithm to the received signal to obtain an initial solution of the transmitted symbol vector comprising a plurality of initial values for the transmitted symbols; hard-demapping each of said initial values to one of said possible transmitted symbols in the constellation plane, in order to form a respective estimated transmitted symbol, the set of estimated transmitted symbols comprising an estimated transmitted symbol vector; defining a selected area in the constellation plane about each estimated transmitted symbol; generating a list of candidate symbol vectors, each candidate symbol vector comprising symbols that are within the respective selected areas surrounding each estimated transmitted symbol, and each candidate symbol vector differing from the estimated transmitted symbol vector only in a subset of the symbols; and applying a decoding technique to the list of candidate symbol vectors.

This has the advantage that the decoding step requires a smaller number of calculations, as the size of the search space is reduced. Moreover, although the decoding step requires a smaller number of calculations, the decoding performance of the receiver is not seriously adversely affected.

According to a second aspect of the present invention, there is provided a receiver operating in accordance with the method of the first aspect of the invention.

According to a third aspect of the present invention, there is provided a communications system, in which the receiver operates in accordance with the method of the first aspect of the invention.

Specifically, by limiting the search space to include only vectors that differ from the initial estimate of the transmitted symbol vector in a restricted number of symbols, the number of calculations can be significantly reduced, without having excessively damaging effects on the symbol error rate.

These and other aspects of the invention will be apparent from and elucidated with reference to the embodiments described hereinafter.

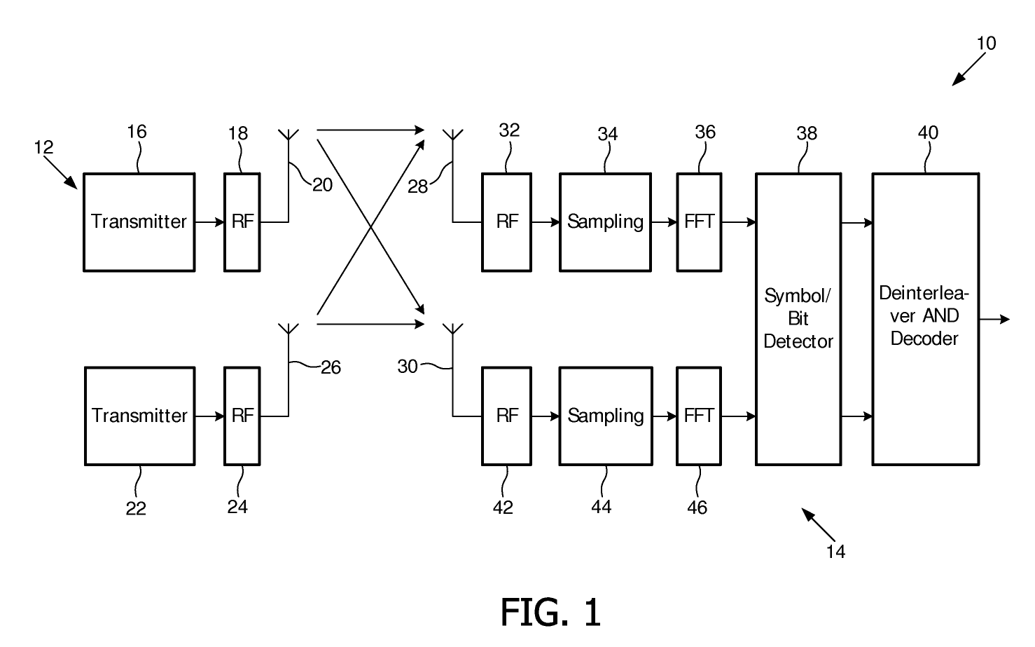

FIG. 1 is a block schematic diagram of a communications system in accordance with an aspect of the invention.

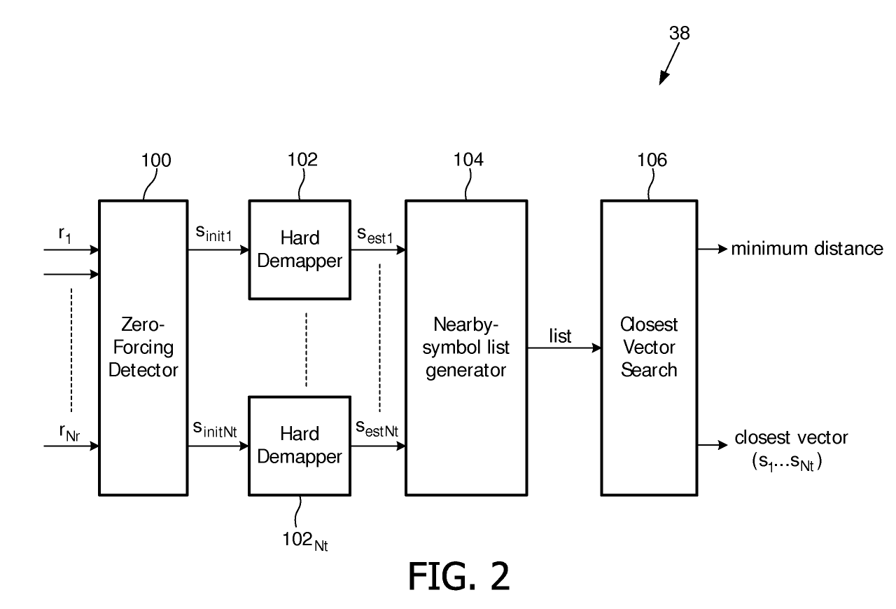

FIG. 2 is a block schematic diagram of a symbol detector in a MIMO receiver in accordance with an aspect of the invention.

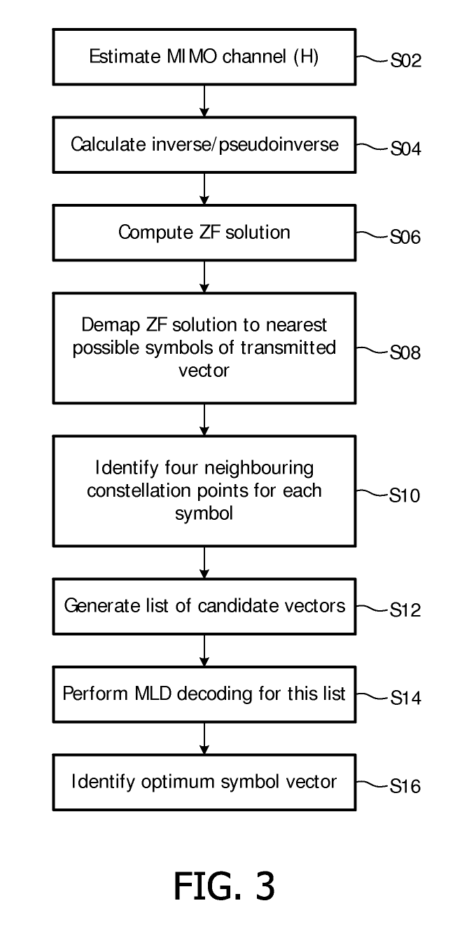

FIG. 3 is a flow chart, illustrating a method of symbol detection in accordance with an aspect of the invention.

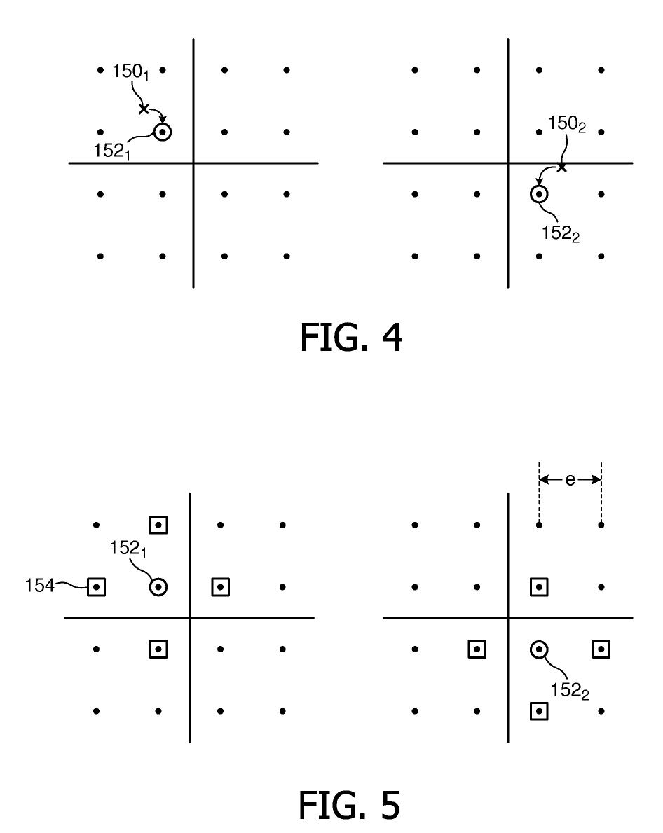

FIG. 4 is a constellation diagram illustrating a step in the method of FIG. 3.

FIG. 5 is a constellation diagram illustrating a further step in the method of FIG. 3.

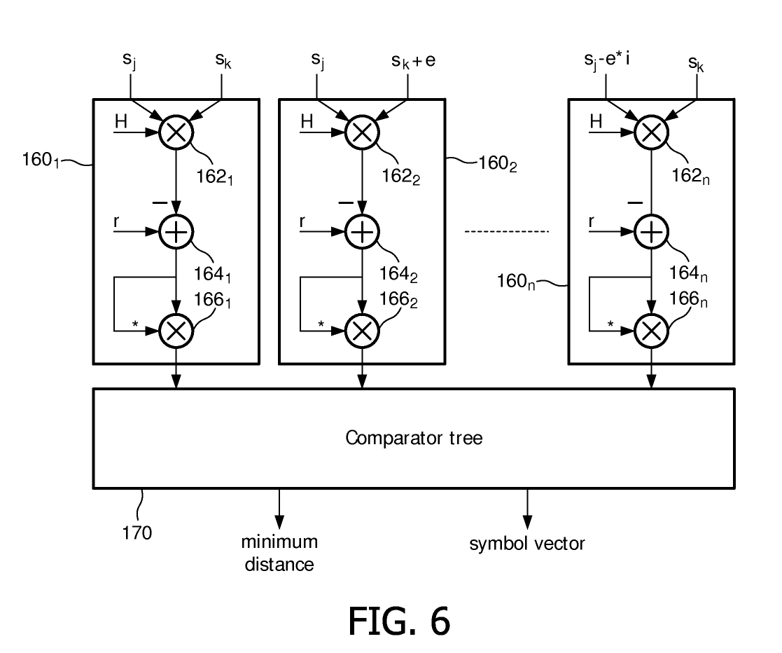

FIG. 6 is a block schematic diagram of a closest vector search block in the symbol detector of FIG. 2.

FIG. 1 is a block schematic diagram of a Multiple Input, Multiple Output (MIMO) communications system 10 in accordance with an aspect of the invention. The communications system 10 includes a transmitter system 12 and a receiver system 14. In this illustrated embodiment of the invention, the communications system 10 is an OFDM system, in which data is modulated onto multiple subcarriers at different frequencies. It will however be apparent to the person skilled in the art that the invention is equally applicable to other systems.

The transmitter system 12 includes first transmitter circuitry 16, connected through first RF circuitry 18 to a first transmit antenna 20. The transmitter system 12 also includes second transmitter circuitry 22, connected through second RF circuitry 24 to a second transmit antenna 26. The transmitter system 12 is generally conventional, and will not be described further herein. Although FIG. 1 shows two separate transmitter circuitry blocks 16, 22, and two separate RF circuitry blocks 18, 24, it will be appreciated that these may be shared as required.

It will further be appreciated that, although FIG. 1 shows two transmit antennas 20, 26, the transmit system 12 may include any desired number of transmit antennas.

Signals from the transmitter system 12 are transmitted from the antennas 20, 26 over an air interface to the receiver system 14.

The receiver system 14 includes two receive antennas 28, 30. Again, although only two receive antennas are shown in FIG. 1, it will be appreciated that the receiver system 14 can include any desired number of receive antennas.

The first receive antenna 28 is connected to first RF receiver circuitry 32, and the output of the first RF receiver circuitry 32 is connected to a first sampling block 34, for forming digital samples of the signal received at the first receive antenna 28. The digital samples are passed to a first FFT block 36, for conversion to the frequency domain. As mentioned above, in this illustrated embodiment, the invention is applied to an OFDM system, and so this conversion to the frequency domain is required. However, the invention is equally applicable to other communications systems.

The output of the first FFT block 36 is passed to a symbol/bit detection block 38. The output demapped symbols are passed to a deinterleaver and decoder block 40, for forming a decoded output signal.

The second receive antenna 30 is connected to second RF receiver circuitry 42, and the output of the second RF receiver circuitry 42 is connected to a second sampling block 44, for forming digital samples of the signal received at the second receive antenna 30. The digital samples are passed to a second FFT block 46, and the output of the second FFT block 46 is passed to the symbol/bit detection block 38. The output demapped symbols are passed to the deinterleaver and decoder block 40.

FIG. 2 is a block schematic diagram of the symbol/bit detection block 38 in the MIMO receiver system 14 in accordance with an aspect of the invention.

The symbol/bit detection block 38 includes a zero-forcing detector block 100. The zero-forcing detector block 100 receives Nᵣ inputs, r₁, . . . , r_{N}_{ᵣ}, where Nᵣ is the number of receive antennas, and creates Nₜ outputs, sᵢₙᵢₜ₁, . . . , s_{initN}_{ₜ} where Nₜ is the number of transmit antennas. It will be appreciated that, although a zero-forcing technique is shown in FIG. 2, other techniques, such as minimum mean square error, are equally applicable. Each output of the zero-forcing detector block 100 is connected to a separate hard demapper 102₁, . . . , 102_{N}_{ₜ}, although it will be appreciated that there could also be a single hard-demapping unit for all Nₜ outputs. Each hard demapper 102₁, . . . , 102_{N}_{ₜ} creates an output sₑₛₜ₁, . . . , s_{estN}_{ₜ} that is connected to a nearby-symbol list generator 104. The nearby-symbol list generator 104 creates a single output, namely a list, which is connected to a closest vector search block 106. The closest vector search block 106 outputs a final solution for the transmitted symbol vector, and its corresponding Euclidean distance from the received vector.

The operation of each block in the symbol/bit detection block 38 will be described in more detail below, and further with reference to FIG. 3.

A model for wireless communication over an Nₜ×Nᵣ MIMO channel (with Nₜ transmit antennas, Nᵣ receive antennas) can be given by the following equation:

r=H*s+n

where r is the received vector, H is the channel matrix, with Nᵣ rows and Nₜ columns, s is the transmitted vector and n is the noise.

The simplest symbol detection technique uses the zero-forcing (ZF) algorithm. This method applies the inverse of the channel matrix H to the received vector r to obtain an output s_{ZF}:

s_{ZF}=H⁻¹*r=s+H⁻¹*n.

The problem with zero forcing is that the inverse of the channel matrix will on average amplify the noise at the receiver, thus making symbol detection more erroneous. Zero forcing, even though simple to implement, gives noisy estimates of the received symbol vector and is a sub-optimal algorithm.

The optimal symbol detection technique is maximum-likelihood detection (MLD), but used conventionally it is computationally expensive. The technique works by computing the Euclidean distance between the received vector r and the product of the channel matrix and a possible transmitted vector sᵢ:

dᵢ²=∥r−H*sᵢ∥².

However, the conventional method is to determine the solution after performing this calculation for all M^{N}^{ₜ} possible transmitted vectors, where M is the constellation size, that is, the number of possible values for each transmitted symbols. Thus, for even a 16 QAM constellation (i.e. having 16 possible values for each transmitted symbol) and 2 transmit antennas, the search space is 256 vectors, with each vector requiring many complex operations.

A process flow is described for carrying out the method of the present invention.

First, a separate detection technique, such as zero forcing or minimum mean square error, is used to determine initial solutions sᵢₙᵢₜ₁, . . . , s_{initN}_{ₜ} corresponding to the symbols transmitted from each of a number of transmit antennas at a given time, where Nₜ is the number of transmit antennas. The complete set of symbols corresponds to a symbol vector (sᵢₙᵢₜ₁, sᵢₙᵢₜ₂, . . . s_{initN}_{ₜ}).

Each initial solution is then hard-demapped on to a nearby one of the nearest possible transmitted symbols, generating an estimated transmitted symbol vector, sₑₛₜ=(sₑₛₜ₁, sₑₛₜ₂, . . . s_{estN}_{ₜ}). In one embodiment of the invention, the initial solution is hard-demapped on to the nearest possible transmitted symbol.

A selected area in the constellation plane is then defined around each of the symbol estimates, encompassing nearby possible transmitted symbols in addition to the symbol estimate itself.

A list of possible transmitted symbol vectors is then generated, including the estimated transmitted symbol vector itself, and all symbol vectors that differ from that vector only in a certain number of symbols and such that the differing symbols are within the selected area defined above.

Finally, a joint detection technique, such as maximum-likelihood detection (MLD), is applied to the vectors in the list to find a final solution. Accordingly, the initial solution is used to define a limited search space for the subsequent joint detection technique, reducing the implementation complexity considerably.

A preferred embodiment of the present method is described in FIG. 3, wherein the detection techniques employed are ZF and MLD, the selected area encompasses only the estimated transmitted symbol and its four nearest neighbors, and the symbol vectors included in the list differ from the estimated transmitted symbol vector in only one symbol.

Accordingly, the MIMO channel matrix H is first determined (step S2). It is to be noted that, although here we assume H to be accurate, this is a nontrivial task and normally H will be an estimate. However, the person skilled in the art will be aware of many channel estimation techniques for determining H, and so this step is not described further. As mentioned above, the channel matrix H is an Nₜ×Nᵣ matrix, where Nₜ is the number of transmit antennas and Nᵣ is the number of receive antennas.

Next, the inverse of the MIMO channel matrix is computed (step S4). Preferably, for MIMO systems having different numbers of transmit and receive antennas, the pseudo-inverse, pseudoinv, will be used, as defined below:

pseudoinv(H)=(H*×H)⁻¹×H*

The channel matrix inverse is then applied to the received vector r according to the ZF approach:

sᵢₙᵢₜ=H⁻¹*r=s+H⁻¹*n

to obtain an initial ZF solution symbol vector sᵢₙᵢₜ, where s is the actual transmitted symbol vector and n is the noise (step S6).

Each symbol of the initial solution is then hard-demapped to the possible transmitted symbol nearest to it in the constellation plane (step S8), defining an estimated transmitted symbol (see FIG. 4). The set of all the estimated transmitted symbols defines the estimated transmitted symbol vector.

FIG. 4 presents an example where there are two transmit antennas. Thus, FIG. 4(a) represents signals transmitted from a first of the transmit antennas, and FIG. 4(b) represents signals transmitted from a second of the transmit antennas. Two 16 QAM signal constellations are therefore shown, with all the possible symbols that could have been transmitted from the transmit antennas represented as dots. In each case, the horizontal and vertical axes represent the in-phase and quadrature components of the transmitted signal, mapped into the complex number plane. The position of each dot represents the magnitude of the in-phase and quadrature components of one of the possible symbols, and hence its magnitude and phase.

In step S6 of the process shown in FIG. 3, an initial symbol vector sᵢₙᵢₜ is obtained by applying the zero-forcing algorithm, as discussed above. The initial symbol vector sᵢₙᵢₜ is formed from initial solutions sᵢₙᵢₜ₁, sᵢₙᵢₜ₂ for the symbols transmitted from the first and second transmit antennas respectively.

The value of the initial solution sᵢₙᵢₜ₁ for the symbol transmitted from the first transmit antenna is represented in FIG. 4(a) as a cross 150₁, while the initial solution sᵢₙᵢₜ₂ for the symbol transmitted from the second transmit antenna is represented in FIG. 4(b) as a cross 150₂.

The action of the hard-demapper, in step S8 of the process shown in FIG. 3, is to map each of the initial solutions 150₁, 150₂ to the respective nearest one of the possible transmitted symbols 152₁, 152₂, each represented in FIGS. 4(a) and 4(b) respectively by a dot in a circle. The nearest possible transmitted symbols 152₁, 152₂ then become the estimated transmitted symbols sₑₛₜ₁, sₑₛₜ₂, which together define the estimated transmitted symbol vector sₑₛₜ.

Returning to FIG. 3, in step S10 a selected area is then defined around each estimated transmitted symbol. In this illustrated embodiment, the selected area includes the estimated transmitted symbol itself and its four nearest neighbors, that is, the symbols immediately above, below, to the left of and to the right of the estimated transmitted symbol in the constellation plane.

FIG. 5 continues the example where there are two transmit antennas. Thus, FIG. 5(a) represents signals transmitted from a first of the transmit antennas, and FIG. 5(b) represents signals transmitted from a second of the transmit antennas. Again, two 16 QAM signal constellations are shown, with all the possible symbols transmitted from the transmit antennas represented as dots. As shown in FIG. 5, each dot is separated by a distance e from each of the adjacent dots in the constellation plane, as represented in the complex number plane.

The estimated transmitted symbols sₑₛₜ₁ and sₑₛₜ₂ are represented as dots in circles 152₁ and 152₂. The four symbols included in the areas defined by step S10 of FIG. 3 are represented as dots in squares 154.

In one embodiment of the invention, if sₑₛₜ is at a corner of the constellation plane then only the two neighbors are considered to be in the selected area, while if sₑₛₜ is on the edge of the constellation plane then only the three neighbors are considered to be in the selected area. However, other possibilities exist. For example, other symbols could be included in the selected area such that the selected area contains the same number of symbols irrespective of the position of sₑₛₜ within the constellation plane.

Returning to FIG. 3, in step S12 a list of candidate transmitted symbol vectors is then generated in the nearby symbol list generator (block 104 in FIG. 2). In this embodiment, the list of candidate transmitted symbol vectors, from which the output value of the transmitted symbol vector is selected, contains the estimated transmitted symbol vector itself, and other symbol vectors which differ from the estimated transmitted symbol vector in just one symbol. Moreover, in the case of that one symbol which differs from the symbol in the estimated transmitted symbol vector, the correct symbol is assumed to be one of the four symbols adjacent to the erroneous estimated symbol, as defined above. In this way, the list of candidate transmitted symbol vectors contains just 4Nₜ+1 vectors out of the total of M^{N}^{ₜ} possible transmitted vectors, where M is the constellation size.

Therefore, for the illustrated example having two transmit antennas with estimated transmitted symbols sₑₛₜ₁ and sₑₛₜ₂ represented by sⱼ and sₖ, the list of candidate transmitted symbol vectors is as follows: (sⱼ, sₖ), (sⱼ+e, sₖ), (sⱼ−e, sₖ), (sⱼ+e.i, sₖ), (sⱼ−e.i, sₖ), (sⱼ, sₖ+e), (sⱼ, sₖ−e), (sⱼ, sₖ+e.i), (sⱼ, sₖ-e.i), where i=√−1, such that adding or subtracting e involves moving a distance e in the horizontal direction in the complex number plane, while adding or subtracting e.i involves moving a distance e in the vertical direction in the complex number plane.

In step S14 of the process shown in FIG. 3, a joint decoding process, in this case Maximum Likelihood Detection (MLD) decoding, is applied to the list of candidate transmitted symbol vectors defined above to find the Euclidean distances dᵢ between the received vector r and each of the candidate transmitted symbol vectors sᵢ according to the equation:

dᵢ²=∥r−H*sᵢ∥².

Thus, the list of candidate transmitted symbol vectors generated in the nearby symbol list generator (block 104 in FIG. 2) is passed to the closest vector search block (block 106 in FIG. 2). FIG. 6 is a schematic block diagram representing a hardware implementation for performing the Maximum Likelihood Detection (MLD) decoding. It will be appreciated that the decoding can take place in hardware or in software, and that the calculations can be performed in parallel as shown in FIG. 6 or in series. Specifically, the two symbols sⱼ and sₖ, which together form a first of the candidate symbol vectors, are input to a calculation block 160₁. The first candidate symbol vector undergoes a multiplication operation in a multiplier 162₁ with the estimated channel matrix H. The output from this step is then subtracted in an adder 164₁ from the received vector r. The output from this subtraction operation is then multiplied by its own complex conjugate (indicated by the asterisk *) to obtain the norm of the Euclidean distance d² for the first candidate symbol vector.

Similarly, the symbols sⱼ and sₖ+e, which together form a second of the candidate symbol vectors, are input to a second calculation block 160₂, and so on, with the symbols sⱼ−e.i and sₖ, which together form the nth of the candidate symbol vectors, are input to the nth calculation block 160ₙ. As shown in FIG. 6, the calculation blocks 160₂, . . . , 160ₙ correspond to the first calculation block 160₁.

In step S16 of the process shown in FIG. 3, the final solution is found by selecting the possible transmitted symbol vector from the list of candidate transmitted symbol vectors, with the smallest Euclidean distance d. Thus, returning to FIG. 6, the outputs of each of the calculation blocks 160₁, . . . , 160ₙ are input into a comparator tree 170, which compares each result, and outputs the symbol vector-minimum distance pair (i.e. the candidate symbol vector with the smallest d², and the value of d itself).

As described above, steps S14 and S16 find the symbol that has the maximum likelihood of having been the transmitted symbol. Thus, the technique described above can be regarded as maximum likelihood symbol detection.

As an alternative, it is possible to perform a maximum likelihood bit detection technique, as described below. Specifically, the symbol/bit detector 38 passes to the deinterleaver and decoder 40 a set of bit-metrics, based on the list of candidate vectors obtained in step S12 of the process of FIG. 3.

In one embodiment of the invention, the bit-metrics can be obtained from log likelihood ratios (LLRs) for each of the bits of the symbol.

Thus, for one bit position in the symbol vector, we form a measure of the likelihood that the transmitted symbol contained a “1” in this bit position, relative to the likelihood that the transmitted symbol contained a “0” in this bit position. The LLR, L, is the log of the quotient of the probability that the transmitted bit bₖ was a “0” (given the received symbol vector, r), and the probability that it was a “1” (also given the received symbol vector, r). That is:

$$L ( {b}_{k} \vert r ) = log ( \frac{P ( {b}_{k} = 0 \vert r )}{P ( {b}_{k} = 1 \vert r )} )$$

In this embodiment of the invention, the computation is simplified by considering only those possibly transmitted symbol vectors that are within the set of candidate vectors identified in step S12 of the process of FIG. 3. Then we divide the set X of the candidate possibly transmitted symbol vectors into two subsets: namely the set X0 of all candidate symbol vectors which have a 0-bit at the given position, and the set X1 of all candidate symbol vectors which have a 1-bit at the given position.

The posterior probability of each symbol vector is proportional to exp(−∥r−Hs∥²). So the total probability that the transmitted bit was a “0”, is equal to the sum over all vectors in X0 of this a posteriori probability, while the total probability that the transmitted bit was a “1” is equal to the sum over all vectors in X1 of this a posteriori probability. That is:

$$L ( {b}_{k} \vert r ) = log \frac{{\sum }_{s ∈ X 0} exp ( \frac{- {‖ r - Hs ‖}^{2}}{2 {σ}^{2}} )}{{\sum }_{s ∈ X 1} exp ( \frac{- {‖ r - Hs ‖}^{2}}{2 {σ}^{2}} )}$$

Again, reducing the size of the search space, by generating a list of candidate vectors as described above, greatly reduces the complexity of these calculations, surprisingly without a correspondingly adverse effect on the results.

There is thus described a method, and an apparatus, for decoding received signals in a MIMO receiver. Although it can be seen that the method and apparatus of the invention are highly efficient, in terms of the number of calculations required in the joint decoding step, and in terms of the implementation of the system in a hardware device, they achieve symbol error rates that are surprisingly close to the symbol error rates achieved by the optimal MLD symbol detector.

1. A method of identifying transmitted symbol vectors as part of a communications system, wherein a plurality of transmitting antennas each transmit a respective symbol during a time period, each symbol being selected from a plurality of possible transmitted symbols, and the plurality of possible transmitted symbols being represented by a constellation plane, wherein the plurality of symbols transmitted by said plurality of transmitting antennas form a transmitted symbol vector, and wherein the method comprises:
receiving a signal over a channel originating from the plurality of transmitting antennas;
applying a first algorithm to the received signal to obtain an initial solution of the transmitted symbol vector comprising a plurality of initial values for the transmitted symbols;
hard-demapping each of said initial values to one of said possible transmitted symbols in the constellation plane, in order to form a respective estimated transmitted symbol, the set of estimated transmitted symbols comprising an estimated transmitted symbol vector;
defining a selected area in the constellation plane about each estimated transmitted symbol;
generating a list of candidate symbol vectors, each candidate symbol vector comprising symbols that are within the respective selected areas surrounding each estimated transmitted symbol, and each candidate symbol vector differing from the estimated transmitted symbol vector only in a subset of the symbols; and
applying a decoding technique to the list of candidate symbol vectors.

2. A method as claimed in claim 1, wherein the first algorithm is zero forcing.

3. A method as claimed in claim 1, wherein the first algorithm is minimum mean square error decoding.

4. A method as claimed in claim 1, wherein the first algorithm uses an estimate of said channel.

5. A method as claimed in claim 1, wherein the decoding technique is maximum-likelihood decoding.

6. A method as claimed in claim 5, wherein the decoding technique comprises maximum-likelihood symbol detection, for identifying a symbol vector from said list of candidate symbol vectors as a solution for the transmitted symbol vector.

7. A method as claimed in claim 5, wherein the decoding technique comprises maximum-likelihood bit detection based on said list of candidate symbol vectors, for forming bit-metrics identifying the likelihood that each bit of the transmitted symbol vector takes particular values.

8. A method as claimed in claim 1, wherein each of said selected areas comprises a maximum of four symbols that are adjacent to the estimated transmitted symbol in the constellation plane, and the estimated transmitted symbol itself.

9. A method as claimed in claim 1, wherein the candidate symbol vectors in the generated list comprise the estimated transmitted symbol vector and a plurality of symbol vectors that differ from the estimated transmitted symbol vector in only one symbol.

10. A method as claimed in Claim 1, wherein the step of hard-demapping each of said initial values to one of said possible transmitted symbols in the constellation plane comprises hard-demapping each of said initial values to the nearest one of said possible transmitted symbols in the constellation plane.

11. A device for receiving signals as part of a communications system, comprising:
receiving circuitry adapted to receive and demodulate signals; and
a decoder adapted to:
apply an algorithm to the received signal to obtain an initial solution of the signal transmitted from each transmitting antenna;
map each initial solution to one possible transmitted symbol, generating an estimated transmitted symbol vector;
define a selected area in the constellation plane about each estimated transmitted symbol;
generate a list of candidate symbol vectors with symbols that are within the selected areas surrounding each estimated transmitted symbol, but differ from the estimated transmitted symbol vector only in a certain number of symbols; and
apply a decoding technique to this list of candidate symbol vectors.

12. A device as claimed in claim 11, wherein the algorithm is zero forcing.

13. A device as claimed in claim 11, wherein the algorithm is minimum mean square error decoding.

14. A device as claimed in claim 11, wherein the decoding technique comprises maximum-likelihood symbol detection.

15. A device as claimed in claim 11, wherein the decoding technique comprises maximum-likelihood bit detection.

16. A device as claimed in claim 11, wherein said selected areas encompass a maximum of four symbols that are adjacent to the estimated transmitted symbol in the constellation plane, and the estimated transmitted symbol itself.

17. A device as claimed in claim 11, wherein the candidate symbol vectors differ from the estimated transmitted symbol vector in only one symbol, or are the estimated transmitted symbol vector itself.

18. A communications system, comprising:
a transmitter;
a plurality of transmitting antennas;
a plurality of receiving antennas;
a sampler;
a symbol detector comprising:
a detector for applying an algorithm to the received signal to obtain an initial solution of the signal transmitted from each transmitting antenna;
a hard demapper to map each initial solution to a possible transmitted symbol, generating an estimated transmitted symbol vector;
a candidate symbol list generator to generate a list of candidate symbol vectors, each comprising symbols that are within selected areas surrounding each estimated transmitted symbol in the constellation plane, but differ from the estimated transmitted symbol vector only in a certain number of symbols; and
a decoder, for applying a decoding technique to the candidate symbol list to obtain a final estimated solution for the transmitted symbol vector.

19. A communications system as claimed in claim 18, wherein said communications system is an OFDM system.

20. A communications system as claimed in claim 19, comprising a FFT processor, for demodulating received signals.
